(19) United States
(12) Patent Application Publication
(10) Pub. No.: US 2017/0008205 A1
(43) Pub. Date: Jan. 12, 2017

(54) APPARATUS AND METHOD FOR INJECTION MOLDING A GOLF BALL

(71) Applicant: Acushnet Company, Fairhaven, MA (US)

(72) Inventors: Ajay Vora, Foxboro, MA (US); Robert A. Wilson, Sagamore, MA (US)

(73) Assignee: Acushnet Company, Fairhaven, MA (US)

(21) Appl. No.: 14/793,116

(22) Filed: Jul. 7, 2015

(51) Int. Cl. B29C 45/14

(52) U.S. Cl. CPC B29C 45/14073; B29L 2031/546

(57) ABSTRACT

The present invention is directed to a retractable pin injection mold system and method of forming a layer of a golf ball using the system. By utilizing a radial gate along with stationary vent pins in the mold, the present invention allows for injection molding of a dimpled outer or inner layer having superior physical properties and more consistent aerodynamics.

### FIELD OF THE INVENTION

The present invention relates to injection molding of a golf ball and, more particularly, to an improved retractable pin injection mold system and method for forming a thin cover over a golf ball.

### BACKGROUND OF THE INVENTION

Conventionally, golf ball covers are made by compression molding two preformed hemispherical cups about a core or by injection molding thermoplastic cover material about a core. In conventional injection molding, it is standard practice to provide a mold having two cavities, each having hemispherical surfaces that mate when the mold is joined. The core of the golf ball is supported centrally within the mold by retractable pins so as to leave a space for molding a cover about the core. A thermoplastic cover material then is injected into the mold cavity in a horizontal plane from a primary supply through a plurality of edge gates. The edge gates typically are evenly distributed near or around the parting line of the mold halves and the equator of the inner hemispherical surface of the golf ball. The retractable pins hold the core in place while the thermoplastic cover material flows from each of the plurality of gates and fills the void between the core and the inside wall of the mold. Once the void is nearly filled, but before the thermoplastic cover material has completely hardened, the centering pins holding the core in place retract so that the thermoplastic cover material may fill the voids left by the pins. The thermoplastic cover material then cools and hardens to form the cover.

However, injection molding processes involving the use of multiple edge gates are subject to technical challenges during manufacturing. For example, multiple edge gate injection molding may result in increased occurrences of knit lines or flow front. In particular, when a golf ball cover is formed using a conventional retractable pin injection molding process with multiple edge gates to inject a thermoplastic material into a mold, the thermoplastic material from each gate has a flow front that eventually abuts cover material entering the mold from other gates. As a result, there are a number of knit lines or flow fronts throughout a cover where cover material from various gates flows together as it fills the void between the golf ball core and the mold. Depending on the composition of the thermoplastic material, the cover material tensile strength can be reduced as much as 10 percent to 60 percent along the knit lines. This leads to balancing problems, as well as reduced durability of the cover.

In addition to resulting in knit lines that may weaken the golf ball cover, conventional multiple edge gate injection molding also may not maintain balanced flow or uniform filling of the thermoplastic cover material between the core and the inside wall of the mold. For example, non-uniform filling can cause the flow terminus of the cover material to not meet at the poles of the ball where trapped air and gasses typically are released through a vent. When the flow terminus is not at the poles of the mold, the trapped air and gasses cannot evacuate the cavity effectively. This non-concentric flow front further compromises knit line integrity and reduces the durability of the cover, especially in thin layer injection molded covers.

The placement and setup of the plurality of edge gates results in further design and manufacturing challenges. For instance, in conventional multiple edge gate injection molding, it is desirable to distribute the plurality of gates symmetrically and equidistance about the mold in order to maintain balanced pressure and flow about the core. However, such a design may interfere with specific dimple patterns that require the gates not be symmetrically spaced about the equator of the ball, such as a staggered wave parting line (“SWPL”) dimple design. The multiple edge gates also, due to the high shear, tend to break during de-mold or trimming operations.

Accordingly, there remains a need for an improved retractable pin injection mold that eliminates or reduces unbalanced, non-uniform flow and produces golf ball layers having reduced stresses/defects and better overall impact durability.

### SUMMARY OF THE INVENTION

The present invention is directed to an injection mold for producing golf balls, including: a first mold half defining a first cavity having a hemispherical inner surface; a second mold half defining a second cavity having a hemispherical inner surface, wherein the first and second cavities join to form a substantially spherical shaped mold cavity; at least one runner for supplying layer-forming material to the mold cavity; and a radial fan gate positioned at an opening of the mold cavity and configured to allow the layer-forming material to flow into the mold cavity.

In this aspect, the first and second mold halves may each include at least one retractable pin and at least one stationary vent pin. In one embodiment, the at least one stationary vent pin is located at a pole of the mold cavity. In another embodiment, the radial fan gate is disposed approximately at the equator of the mold cavity. In yet another embodiment, the at least one runner includes at least one primary runner in communication with at least one secondary runner. The at least one runner may also further include at least one tertiary runner in communication with at least one secondary runner and the radial fan gate.

The present invention is also directed to an injection mold for producing golf balls, including: a first mold half defining a first cavity having a hemispherical inner surface; a second mold half defining a second cavity having a hemispherical inner surface, wherein the first and second cavities join to form a substantially spherical shaped mold cavity; at least one primary runner for supplying layer-forming material; at least one secondary runner disposed around the mold cavity and connected to the primary runner such that the secondary runner is in communication with the primary runner; and at least one tertiary runner extending directly to an opening of the mold cavity via a radial fan gate and connected to the secondary runner such that the tertiary runner is in communication with the secondary runner, wherein the radial fan gate is positioned at the opening of the mold cavity and configured to allow the layer-forming material to flow into the mold cavity with a uniform flow front.

In this aspect of the invention, the first and second mold halves each include at least one retractable pin and at least one stationary vent pin. In one embodiment, the at least one stationary vent pin is located at a pole of the mold cavity. In another embodiment, the radial fan gate is disposed approximately at the equator of the mold cavity. In still another embodiment, the first and second cavities join to form a staggered wave parting line.

The present invention is further directed to a method for injection molding a golf ball layer about an inner ball, including: positioning an inner ball into an injection mold having a substantially spherical shaped mold cavity comprising first and second mold halves; supplying layer-forming material from a primary runner to a secondary runner disposed around the mold cavity; supplying the layer-forming material from the secondary runner to a tertiary runner, wherein the tertiary runner extends directly to an opening of the mold cavity via a radial fan gate; substantially filling the tertiary runner with the layer-forming material; equalizing the pressure at the tertiary runner; injecting the layer-forming material into the mold cavity through the radial fan gate; curing the layer-forming material to form a golf ball; and removing the golf ball from the mold.

In this aspect, the method may further include extending a plurality of retractable pins into the mold cavity to securely position the inner ball prior to the step of injecting the layer-forming material into the mold cavity. In another embodiment, the method of the present invention may further include withdrawing the plurality of retractable pins from the mold cavity before the injected layer-forming material contacts the retractable pins. In still another embodiment, the method includes surface treating the inner ball prior to the step of positioning or after the step of removing the golf ball from the mold. In yet another embodiment, the first and second mold halves may each include a hemispherical cavity including a negative dimple pattern. In addition, the golf ball may have a staggered wave parting line.

### BRIEF DESCRIPTION OF THE DRAWINGS

Further features and advantages of the invention can be ascertained from the following detailed description that is provided in connection with the drawing(s) described below:

FIGS. 1A and 1B illustrate top plan views of mold halves contemplated by the present invention;

FIG. 2A illustrates a sectional view (I-I) of the mold half of FIGS. 1A and 1B;

FIG. 2B illustrates an exploded view of the sectional view (I-I) shown in FIG. 2A; and

FIGS. 3A and 3B illustrate top plan views of one embodiment of a branching runner system connected to a plurality of molds contemplated by the present invention;

FIG. 4 illustrates a sectional view (II-II) of the branching runner system connected to a plurality of molds of FIGS. 3A and 3B;

FIG. 5 illustrates one embodiment of a radial fan gate; and

FIG. 6 illustrates a flow chart for the steps of a method of using the injection mold of the present invention.

### DETAILED DESCRIPTION OF THE INVENTION

The present invention is directed to a retractable pin injection mold (“RPIM”) system and method of forming a thin outer cover, inner cover layer, intermediate layer, or outer core layer of a golf ball using the RPIM system. In particular, the present invention is believed to reduce or eliminate the problems associated with flow fronts and knit lines that result from using a plurality of edge gates. Indeed, golf balls produced using the present invention have improved physical, aerodynamic, and cosmetic properties. By utilizing a radial fan gate along with stationary vent pins in the RPIM system, the present invention allows for injection molding of a dimpled outer cover having a staggered wave parting line (“SWPL”) or non-SWPL dimple design or an inner golf ball layer to result in a finished golf ball with superior physical properties and more consistent aerodynamics.

For example, in one embodiment, the present invention provides uniform and concentric flow front that allows for precise retraction of the pins before the cover material contacts the pins. This leads to increased cover durability. In addition, contrary to edge gates that can move the core of the ball due to varying forces, the present invention provides equal pressure to be exerted on the core during injection of the material to maintain the core in the center of the mold. Further, the present invention allows for the ability to injection mold covers having a SWPL dimple design as well as to injection mold thin layers having better concentricity.

### The System of the Invention

The RPIM system of the invention includes mold plates including molds, a runner system, and radial gates, as well as material reservoirs. Each of the components of the system of the invention is discussed below.

The Mold

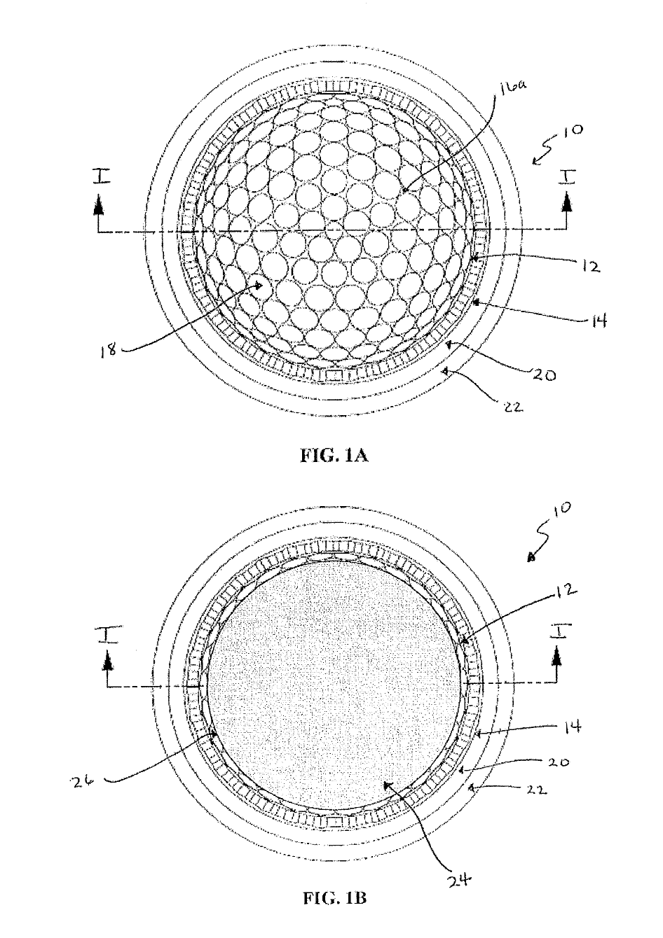

The mold includes opposing mold components defined by two mold halves that cooperate to form a mold. Each mold half, in turn, defines a corresponding substantially hemispherical cavity and has a mating surface surrounding the hemispherical cavity and facing opposing mold half. In particular, as shown in FIG. 1A, each mold half 10 has a hemispherical cavity 12 formed therein and a circumferential mating surface 14 surrounding the hemispherical cavity 12 and facing the opposing mold half When the mold halves are brought together, with the mating surfaces 14 in full contact with each other, the two hemispherical cavities 12 together define a substantially spherical mold cavity (not shown). The mating surfaces 14 of the corresponding mold halves 10 may be planar, non-planar, or offset from the equator of the ball to be formed. The mating surfaces of the mold halves 10 may be substantially smooth. In another embodiment, mating surfaces of the mold halves 10 may be designed such that at least the mating surface 14 creates a staggered wave parting line (SWPL).

The inner surfaces 16a of the mold halves 10, defining hemispherical cavities 12, may be smooth or textured according to the desired texture of the surface of the ball layer formed. In one embodiment, the inner surfaces 16a include a negative dimple pattern with a plurality of protrusions 18 that form dimples in the finished golf ball layer. Since the use of various dimple patterns and profiles provide a relatively effective way to modify the aerodynamic characteristics of a golf ball, the manner in which the dimples are arranged on the surface of the ball may be by any available method. For instance, the cavities 12 may have a negative icosahedron-based dimple pattern, a tetrahedral-based dimple pattern, or an octahedral-based dimple pattern. Advantageously, the present invention dispenses of the need to place a plurality of gates in symmetry and equidistance from each other, which often interferes with a SWPL. Accordingly, in one embodiment, the golf ball formed by the present invention includes a dimple pattern having a SWPL.

Before the mold plates are joined, a substantially spherical golf ball product, i.e., the inner ball, is placed into one of the mold cavities 12. For example, FIG. 1B illustrates an inner ball 24 placed within the mold cavity 12. When the inner ball 24 is positioned within the mold cavity 12 of the mold half 10 and the opposing mold half is joined with the mold half containing the inner ball 24, the inner ball 24 is essentially evenly spaced circumferentially from the inner surface 16a of the mold cavity 12 so that a layer may be formed with a substantially consistent thickness in the empty layer of space over the inner ball 24. In one embodiment, the thickness of the empty layer of space 26 between the inner ball 24 and the inner surface 16a of the mold cavity 12 preferably varies by less than about 0.005 inches at any point around the circumference.

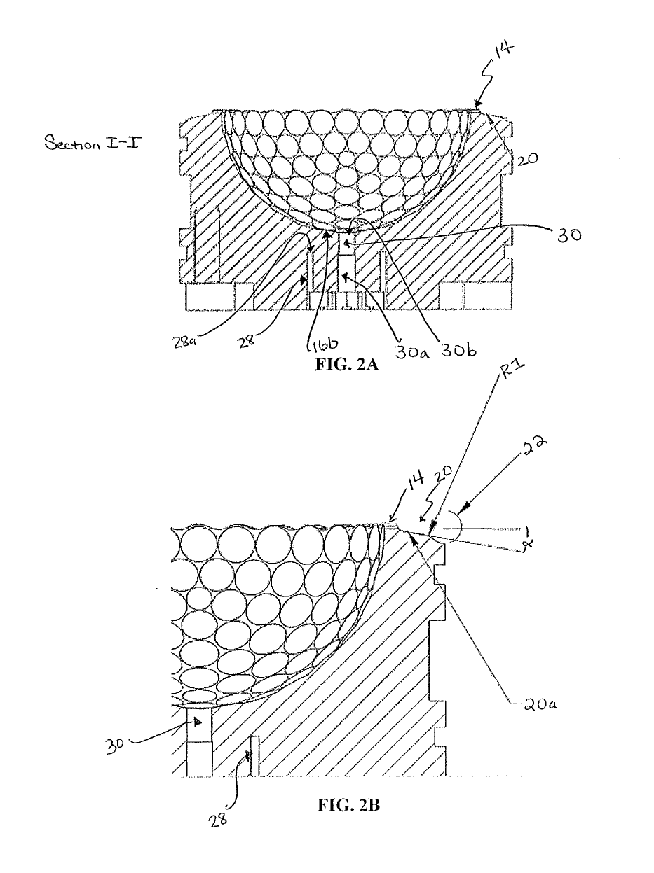

In an effort to effect such consistency in the thickness of the empty layer of space 26, each mold half 10 also includes a plurality of retractable pins 28, as shown in FIG. 2. While not shown in FIG. 2, the retractable pins 28 extend through each mold half 10 into the mold cavity 12 and are configured to support the inner ball 24 in a predetermined position within the mold cavity 12 when the inner ball 24 is placed within the mold cavity 12 during the initial stage of the injection process. In particular, the retractable pins 28 are engaged with the inner ball 24 until the injected material is substantially evenly disposed about the inner ball 24 to fill the empty layer of space 26. In one embodiment, the retractable pins 28 are disengaged from the inner ball 24 before the injected material contacts the retractable pins 28. In another embodiment, the retractable pins 28 remain engaged with the inner ball 24 when the injected material contacts the retractable pins 28 providing that the retractable pins 28 are disposed a uniform distance from the poles of the mold cavity 12 such that the injected material reaches the retractable pins 28 at approximately the same time. Indeed, as discussed below, the present invention and, in particular, the use of a radial fan or flash gate or and runner system allows for balanced flow and pressure of injected material.

When disengaged from the inner ball 24, the retractable pins 28 withdraw until the surface 28a of the pins are flush with the inner surface 16a of the mold cavity 12. The number and arrangement of retractable pins may vary according to the type of layer being applied. The surfaces 28a of the retractable pins 28 may be shaped to form dimples on the ball cover. For example, in one embodiment, when the layer is added as an outermost cover layer, the number, arrangement, and surfaces 28a of retractable pins 28 may vary according to the dimple pattern and/or dimple size(s).

As shown in FIG. 2, each mold half also has a stationary vent pin 30 that extends through the outer surface of mold cavity 12. The diameter of the vent pin is slightly smaller than the bore 30a that it penetrates to permit excess air and other gases to escape as cover material is injected into the mold. Surface 30b of vent pin 30 extends through the outer surface 16b of the mold cavity 12 to form a portion of the inner surface 16a of the mold cavity 12, thus, is preferably shaped to form a dimple in the molded layer. In one embodiment, the vent pin 30 is located at the cover material flow terminus so that no air or other gases will remain trapped in the mold. In this aspect of the invention, the flow terminus is located at or near the poles of the mold. Accordingly, it is preferred that each mold half include at least one stationary vent pin such that the vent pins are disposed near the upper and lower poles of the mold. In particular, FIG. 2 illustrates a vent pin 30 at a lower pole of the mold.

Each mold half also includes a radial gate that extends around the circumference of the mold cavity 12 and is positioned at the opening of the mold cavities to allow for a continuous balanced fill of the injection material 360 degrees around the circumference of the golf ball. In particular, as shown in FIGS. 1A and 1B, the radial gate 20 is adjacent to the mating surface 14 of the mold half 10 such that it controls the flow of the injection material into the mold cavity 12. A radial runner 22 is adjacent to and in communication with the radial gate 20 and, thus also extends around the circumference of the mold cavity 12. The radial gate may be a fan gate or a flash gate. In one embodiment, the radial gate is a fan gate.

As shown in FIG. 2B, a fan gate suitable for use with the present invention has an angle α. As will be appreciated by one of ordinary skill in the art, the fan gate should be angled such that the gate does not take out the bottom of the radial runner 22. Thus, in one embodiment, a fan gate suitable for use with the present invention has an angle α ranging from about 5° to about 20°. In another embodiment, the angle a of the fan gate ranges from about 8° to about 18°. In still another embodiment, the angle α of the fan gate ranges from about 9° to about 15°. In yet another embodiment, the angle α of the fan gate ranges from about 9° to about 12°. For example, the present invention contemplates a 10° radial fan gate.

The radial fan gate 20 is flared into the mold cavity 12 with a transition fillet 20a. In one embodiment, the fillet 20a has a diameter of about 0.060 inches to about 0.200 inches. In another embodiment, the fillet 20a has a diameter of about 0.080 inches to about 0.180 inches. In still another embodiment, the fillet 20a has a diameter of about 0.100 inches to about 0.150 inches. For example, the present invention contemplates a transition fillet 20a having a diameter of about 0.140 inches.

The radial fan gate 20 is positioned such that there is a blend radius, represented by R1, from the fan gate 20 to the adjacent radial runner 22. The blend radius should be designed such that the blend radius does not obstruct the flow of material from the radial runner 22 to the fan gate 20. For example, the blend radius R1 ranges from about 0.100 inches to about 0.250 inches. In another embodiment, the blend radius R1 ranges from about 0.120 inches to about 0.215 inches. In still another embodiment, the blend radius R1 ranges from about 0.140 inches to about 0.200 inches. In yet another embodiment, the blend radius R1 ranges from about 0.140 inches to about 0.187 inches.

In another embodiment, the fan gate 20 has a width of about 0.020 inches to about 0.060 inches. For example, the fan gate 20 has a width of about 0.025 inches to about 0.055 inches. In another embodiment, the fan gate 20 has a width of about 0.030 inches to about 0.050 inches. In still another embodiment, the fan gate 20 has a width of about 0.035 inches to about 0.045 inches.

In yet another embodiment of the present invention, the radial gate is a flash (or film) gate. In this aspect of the invention, the gate is thin. For example, the present invention contemplates a fan gate 20 having a thickness that is about 30 percent of the thickness of the formed cover (i.e., the layer represented by 26 in FIG. 1B). In another embodiment, the thickness of the gate 20 is about 0.005 inches to about 0.015 inches. In still another embodiment, the thickness of the gate 20 is about 0.010 inches to about 0.012 inches. The adjacent radial runner is also relatively thin, e.g., about 0.02 inches to about 0.04 inches.

The Runner System

The pathway by which the injection material flows to the golf ball molds may be a runner system. While any runner system is suitable, including, but not limited to, a standard herringbone runner system, a radial runner system, and the like, in one embodiment, the material is injected into the molds through a branched runner system that directs the flow of the injection material to a plurality of molds. In this aspect, the branched runner system includes at least a primary runner and a secondary runner. In another embodiment, the branched runner system includes at least a primary runner, a secondary runner, and a tertiary runner. However, it is to be understood that more than one primary, secondary, or tertiary runner may be utilized in accordance with the present invention.

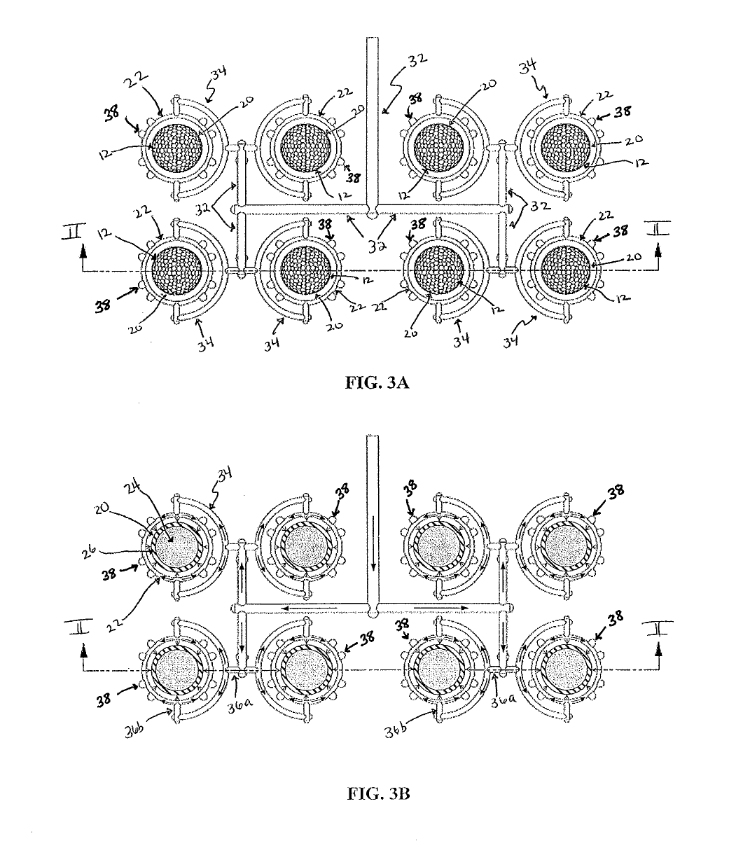

For example, FIG. 3A depicts a top view of a branched runner system that is connected to eight (8) different molds (shown here as a top view with exposed mold cavities 12). As shown in

FIG. 3A, the runner system includes primary runners 32, secondary runners 34, and tertiary runners 22 (also referred to above as the adjacent radial runner) located within a horizontal plane near the parting line of each of the mold cavities 12. The branched runner system ends at the opening of each mold cavity 12. The primary runner 32 is connected to a reservoir (not shown) that houses the injection material. During the injection molding process, the primary runner 32 supplies the injection material from the reservoir to the secondary runners 34. As stated previously, more than one primary runner 32 may be used to fill the secondary runners 34. For example, in one embodiment, two primary runners 32 are disposed at opposite ends of the secondary runner 34.

In one embodiment, the cross section of the primary runner 32 is circular in shape. As will be apparent to one of ordinary skill in the art, other shapes may be equally suitable. The primary runner 32 has a cross-sectional area of about 0.135 square inches to about 0.160 square inches. In another embodiment, the primary runner 32 has a cross-sectional area of about 0.037 square inches to about 0.055 square inches.

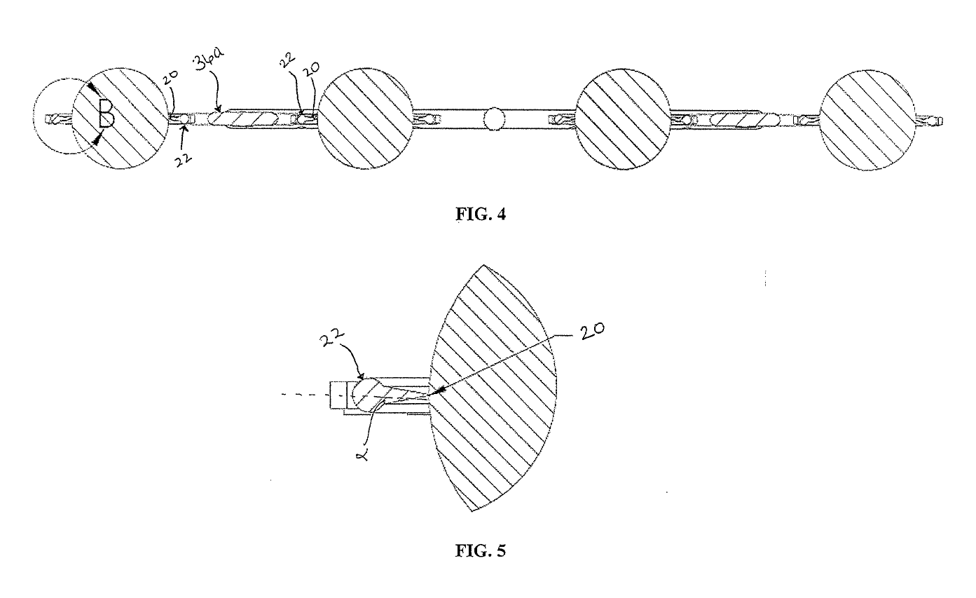

As shown in FIG. 3A, the secondary runners 34 are positioned as continuous annular pathways around each of the mold cavities 12. FIG. 3B illustrates the general flow of the injection material from the primary runners 32 to the second runners 34. In one embodiment, the secondary runner 34 is disposed substantially in a plane around the mold cavity 12 such that the flow of material from the primary runner 32 is introduced into the secondary runner 34 in a direction essentially perpendicular to the plane. In one embodiment, a runner junction (shown generally as 36a in FIGS. 3B and 4) is used to redirect the flow of injection material from the horizontal plane toward the secondary runners 34 through a section of runner that departs from the horizontal plane at an angle approximately perpendicular to the horizontal plane. In one embodiment, the runner junction is a melt flipper. The runner junction may include a vertical runner section that forms a T-intersection with the branches of the runner system.

While the secondary runner may be sized and positioned to achieve desired flow characteristics, it is preferred that the secondary runner be located between about 0.15 inches to about 0.30 inches from the mold cavity 12 to the centerline of the secondary runner 34. In another embodiment, the secondary runner is located between about 0.20 inches to about 0.24 inches from the mold cavity 12 to the centerline of the secondary runner 34.

In one embodiment, the cross section of the secondary runner 34 is circular in shape. As will be apparent to one of ordinary skill in the art, other shapes may be equally suitable. However, the secondary runner 34 should be dimensioned to have an area that is large enough to provide easy flow there through. In addition, the cross section of the secondary runner 34 may be uniform about the mold. In another embodiment, the secondary runner 34 may have varying cross sections, for example, having increased and decreased diameters if the cross section of the secondary runner 34 is essentially circular to facilitate substantial filling of the secondary runner 34. In one embodiment, the secondary runner 34 has a cross-sectional area of about 0.021 square inches to about 0.032 square inches. In another embodiment, the secondary runner 14 has a cross-sectional area of about 0.0003 square inches to about 0.0006 square inches.

Once the injection material substantially fills the secondary runners 34, the injection material flows to the tertiary runners 22 that lead directly to the mold cavities 12. FIG. 3B illustrates the general flow of the injection material from the secondary runners 34 to the tertiary runners 22. As with the flow of injection material from the primary runners 32 to secondary runners 34, a runner junction 36b may be used to redirect the flow of the injection material from the horizontal plane during transition from the secondary runners 34 to the tertiary runners 22. The tertiary runners 22 feed the injection material to an opening of the mold cavity 12 via the radial gate 20, as shown in FIG. 3B. Similar to the primary and secondary runners, the cross section of the tertiary runner 22 is circular in shape. In one embodiment, the tertiary runner 22 has a cross-sectional area of about 0.015 square inches to about 0.045 square inches. In another embodiment, the tertiary runner 22 has a cross-sectional area of about 0.025 square inches to about 0.030 square inches.

In one embodiment, the radial gate 20 allows the injection material to enter at or near the parting line of the mold cavity and travel toward the poles of the golf ball cavity. In another embodiment, the injected material enters the mold cavity near the poles and travels toward the parting line of the golf ball mold.

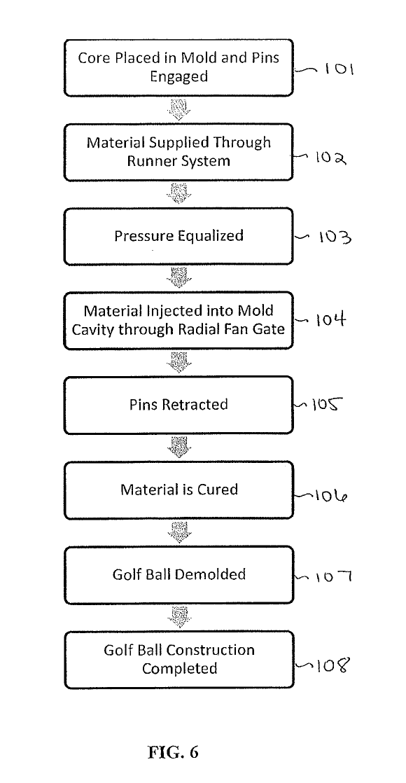

FIG. 4 shows a cross-sectional view taken along II-II of FIGS. 3A and 3B. As shown in FIG. 4, the tertiary runners 22 flow the injection material into each of the mold cavities 12 through a radial gate 20. As shown in FIG. 4, the radial gate 20 extends from the tertiary runner 22 to the opening of the mold cavity 12. FIG. 5 is an exploded view of B in FIG. 4.

After the injection material enters each of the mold cavities 12 and the material hardens, a plurality of knock-out pads 38 (shown in FIGS. 3A and 3B) arranged along the circumference of each mold cavity 12 may aid in removing the formed golf ball from the mold cavity 12.

### Method of Forming an Injection Molded Layer

The present invention contemplates the use of the RPIM system to form at least one layer of two-piece, three-piece and multi-piece golf balls. Thus, in one embodiment, the inner ball 24 referenced above may be a core. In another embodiment, the inner ball 24 is a core with one or more intermediate layers or inner cover layers formed thereon. As such, any references to inner ball are intended to represent any golf ball component prior to adding an additional outer layer thereon. In one embodiment, the layer added to the inner ball 24 using the RPIM system is the outermost cover layer.

FIG. 6 illustrates one embodiment of a method contemplated by the present invention. At step 101, the inner ball 24 is placed inside the mold cavity 12 and the plurality of retractable pins 28 are engaged to securely hold the inner ball 24 in place. At step 102, the injection material is supplied through the runner system (initiating from the material stored in reservoirs or tanks upstream). The injection material is supplied from the primary runner 32 to the secondary runner 34 positioned around the mold cavity 12. From the secondary runner 34, the injection material is then supplied to the tertiary runner 22. In one embodiment, step 102 is completed within about 300 milliseconds. At step 103, once the tertiary runner 22 fills with the injection material, the pressure is equalized within the tertiary runner 22.

In step 104, the injection material is forced through the radial gate 20 into the mold simultaneously filling the space between the inner ball 24 and inner surfaces 16a of the mold cavities 12 and thus forming a layer of substantially constant thickness about the inner ball 24. In particular, the radial gate 22 of the present invention advantageously allows the injection material to enter the empty layer of space 26 as a single, uniform flow front. In turn, the injection material forces the trapped gas toward the stationary vent pins 30 as the melt front approaches the plurality of retractable pins 28 and prevents the formation of knit lines. The use of the radial gate of the present invention also allows the flow front to move more accurately within and among multiple cavities allowing better precision in retracting the retractable pins 28. This allows for the retractable pins 28 to avoid contact with the injection material while the pins 28 are in the extended position. In one embodiment, step 104 is completed within about 400 milliseconds to about 500 milliseconds.

At step 105, once the inner ball 24 is securely held in position by the injection material, the retractable pins 28 may be disengaged from the inner ball 24. Injection of material continues until the mold 10 is completely filled. At step 106, the injection material is allowed to cool and harden. Once the injection material has sufficiently cooled, in step 107, the mold 10 is opened and the golf ball is removed for further processing. In one embodiment, step 108 may indicate continued layer disposition if additional layers are contemplated.

If the injection material represents the outermost cover layer, step 108 may also include post-finishing treatments such as painting, coating, or surface treating. For example, when the golf ball product ultimately will receive a coating layer, a surface treatment of the outermost layer of the golf ball may be effected to improve adhesion between those layers. The surface treatment may include mechanical abrasion, e.g., sandblasting; plasma treatment, including treatment at atmospheric pressure; corona treatment; flame treatment; wet chemical surface modification; application of adhesives or adhesion promoters; and combinations thereof. Similarly, such surface treatments may be applied to the inner ball prior to the injection molding process described herein.

Furthermore, golf balls may be coated with urethanes, urethane hybrids, ureas, urea hybrids, epoxies, polyesters, acrylics, or combinations thereof in order to obtain an extremely smooth, tack-free surface. If desired, more than one coating layer can be used. The coating layer(s) may be applied by any suitable method known to those of ordinary skill in the art.

### Injection Materials

The injection materials that may be used with the present invention include any type of polymeric material that is hard and impact-sensitive. Suitable layer-forming materials include, but are not limited to, partially neutralized ionomers; bimodal ionomers, such as Surlyn® AD 1043, 1092, and 1022 ionomer resins, commercially available from E. I. du Pont de Nemours and Company; ionomers modified with rosins; polyolefins; polyamides; polyesters; polyethers; polycarbonates; polysulfones; polyacetals; polylactones; acrylonitrile-butadiene-styrene resins; polyphenylene oxide; polyphenylene sulfide; styrene-acrylonitrile resins; styrene maleic anhydride; polyimides; aromatic polyketones; ionomers and ionomeric precursors, acid copolymers, and conventional HNPs; polyurethanes; grafted and non-grafted metallocene-catalyzed polymers, such as single-site catalyst polymerized polymers, high crystalline acid polymers, cationic ionomers, and combinations thereof.

Additives and fillers may be added to one or more layers of the golf ball with the layer-forming material. In one embodiment, the additives and/or fillers may be present in an amount of from 0 weight percent to about 50 weight percent, based on the total weight of the composition. In another embodiment, the additives and/or fillers may be present in an amount of from about 5 weight percent to about 30 weight percent, based on the total weight of the composition. In still another embodiment, the additives and/or fillers may be present in an amount of from about 10 weight percent to about 20 weight percent, based on the total weight of the composition.

Suitable additives and fillers include, but are not limited to, chemical blowing and foaming agents, optical brighteners, coloring agents, fluorescent agents, whitening agents, UV absorbers, light stabilizers, defoaming agents, processing aids, mica, talc, nano-fillers, antioxidants, stabilizers, softening agents, fragrance components, plasticizers, impact modifiers, TiO₂, acid copolymer wax, surfactants, and fillers, such as zinc oxide, tin oxide, barium sulfate, zinc sulfate, calcium oxide, calcium carbonate, zinc carbonate, barium carbonate, clay, tungsten, tungsten carbide, silica, lead silicate, regrind (recycled material), and mixtures thereof

### Golf Ball Construction

As discussed briefly above, the injection material may be used to form a layer with any type of ball construction depending on the type of performance desired of the ball. If the layer formed using the RPIM system is the outermost cover, the cover may have a thickness ranging from about 0.02 inches to about 0.08 inches. In one embodiment, the cover formed with the injection material is about 0.02 inches to about 0.050 inches. In another embodiment, the cover has a thickness of from about 0.025 inches to about 0.040 inches. In yet another embodiment, the cover formed has a thickness of from about 0.025 inches to about 0.035 inches. If the layer formed using the RPIM system is an inner layer, i.e., any layer(s) disposed between the inner core and the outer cover of a golf ball, the layer may have a thickness of about 0.020 inches to about 0.050 inches and may be disposed about a core. In one embodiment, the layer may have a thickness of about 0.02 inches to about 0.045 inches. In another embodiment, the layer may have a thickness of about 0.025 inches to about 0.04 inches.

### EXAMPLES

The following non-limiting examples demonstrate golf balls made in accordance with the present invention. The examples are merely illustrative of the preferred embodiments of the present invention, and are not to be construed as limiting the invention, the scope of which is defined by the appended claims.

### Example 1

A retractable pin injection molded golf ball cover having a staggered wave parting line was produced in accordance with the present invention. The golf ball cover was produced under the following processing conditions, as set forth in Table 1 below:

TABLE 1
PROCESSING CONDITIONS FOR PRODUCTION OF
RPIM SWPL COVER ACCORDING TO EXAMPLE 1
CORE

| Composition | Polybutadiene | |
|---|---|---|
| Core Diameter | 1.550 | inches |

COVER BLEND

| Composition | 40% Surlyn ® 8528 | |
|---|---|---|
| | 60% Surlyn ® 9650 | |
| Melt Flow Index | 1.73 g/10 min. | |
| THICKNESS OF FLASH GATE | 0.011 | inches |
| CYCLE TIME | 30 | seconds |

The golf ball cover produced in accordance with the parameters of Table 1 underwent testing to determine the concentricity of the golf ball. For example, to determine the concentricity of the golf ball, the cover was cut open to determine the distance the core shifted during the injection molding process. The golf ball produced in accordance with the present

Example demonstrated superior concentricity. Indeed, due to the concentric fill provided by the present invention, the golf ball exhibited minimal shifting (e.g., from about 0.0052 inches to about 0.0122 inches) during the injection molding process.

In addition, the golf ball cover produced in accordance with the parameters of Table 1 underwent testing to determine the durability of the cover. For example, to determine the durability of the cover, the cover was hit about 400 times using a standard hitting machine. The cover produced in accordance with the present invention sustained 400 hits without any failures. Indeed, the present invention provides less shear at the flash gate and virtually insignificant flow line boundaries, leading to enhanced durability in the formed golf ball cover.

### Example 2

A retractable pin injection molded golf ball cover having a staggered wave parting line is produced in accordance with the present invention. The golf ball cover is produced under the same processing conditions as described in Table 1 above with the exception of the cover blend. The cover blend of the instant Example utilizes a cover blend material having a melt flow index of about 2.3 g/10 min.

The golf ball produced in accordance with the instant Example undergoes similar testing as described in Example 1 to determine the concentricity and the durability of the cover. The golf ball of Example 2 demonstrates even better concentricity and durability than that of Example 1. For example, the golf ball cover produced in accordance with the instant Example exhibits no shifting during the injection molding process and is able to sustain 600 hits without any failures.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All patents and patent applications cited in the foregoing text are expressly incorporated herein by reference in their entirety.

What is claimed is:

1. An injection mold for producing golf balls, comprising:
a first mold half defining a first cavity having a hemispherical inner surface;
a second mold half defining a second cavity having a hemispherical inner surface, wherein the first and second cavities join to form a substantially spherical shaped mold cavity;
at least one runner for supplying layer-forming material to the mold cavity; and
a radial fan gate positioned at an opening of the mold cavity and configured to allow the layer-forming material to flow into the mold cavity.

2. The injection mold of claim 1, wherein the first and second mold halves each comprise at least one retractable pin and at least one stationary vent pin.

3. The injection mold of claim 2, wherein the at least one stationary vent pin is located at a pole of the mold cavity.

4. The injection mold of claim 1, wherein the radial fan gate is disposed approximately at the equator of the mold cavity.

5. The injection mold of claim 1, wherein the at least one runner comprises at least one primary runner in communication with at least one secondary runner.

6. The injection mold of claim 5, wherein the at least one runner further comprises at least one tertiary runner in communication with at least one secondary runner and the radial fan gate.

7. An injection mold for producing golf balls, comprising:
a first mold half defining a first cavity having a hemispherical inner surface;
a second mold half defining a second cavity having a hemispherical inner surface, wherein the first and second cavities join to form a substantially spherical shaped mold cavity;
at least one primary runner for supplying layer-forming material;
at least one secondary runner disposed around the mold cavity and connected to the primary runner such that the secondary runner is in communication with the primary runner; and
at least one tertiary runner extending directly to an opening of the mold cavity via a radial fan gate and connected to the secondary runner such that the tertiary runner is in communication with the secondary runner, wherein the radial fan gate is positioned at the opening of the mold cavity and configured to allow the layer-forming material to flow into the mold cavity with a uniform flow front.

8. The injection mold of claim 7, wherein the first and second mold halves each comprise at least one retractable pin and at least one stationary vent pin.

9. The injection mold of claim 8, wherein the at least one stationary vent pin is located at a pole of the mold cavity.

10. The injection mold of claim 7, wherein the radial fan gate is disposed approximately at the equator of the mold cavity.

11. The injection mold of claim 7, wherein the first and second cavities join to form a staggered wave parting line.

12. A method for injection molding a golf ball layer about an inner ball, comprising:
positioning an inner ball into an injection mold having a substantially spherical shaped mold cavity comprising first and second mold halves;
supplying layer-forming material from a primary runner to a secondary runner disposed around the mold cavity;
supplying the layer-forming material from the secondary runner to a tertiary runner, wherein the tertiary runner extends directly to an opening of the mold cavity via a radial fan gate;
substantially filling the tertiary runner with the layer-forming material;
equalizing the pressure at the tertiary runner;
injecting the layer-forming material into the mold cavity through the radial fan gate;
curing the layer-forming material to form a golf ball; and
removing the golf ball from the mold.

13. The method of claim 12, further comprising extending a plurality of retractable pins into the mold cavity to securely position the inner ball prior to the step of injecting the layer-forming material into the mold cavity.

14. The method of claim 13, further comprising withdrawing the plurality of retractable pins from the mold cavity before the injected layer-forming material contacts the retractable pins.

15. The method of claim 12, further comprising surface treating the inner ball prior to the step of positioning.

16. The method of claim 12, further comprising surface treating the golf ball after the step of removing the golf ball from the mold.

17. The method of claim 12, wherein the first and second mold halves each comprise a hemispherical cavity comprising a negative dimple pattern.

18. The method of claim 12, wherein the golf ball has a staggered wave parting line.
